(19) United States
(12) Patent Application Publication
(10) Pub. No.: US 2013/0176209 A1
(43) Pub. Date: Jul. 11, 2013

(54) INTEGRATION SYSTEMS AND METHODS FOR VEHICLES AND OTHER ENVIRONMENTS

(71) Applicant: Nfuzion Inc., Fayetteville, GA (US)

(72) Inventors: David Kristian HANON, Dayton, VA (US); Gareth Williams, Ann Arbor, MI (US); Randy Tyner, Greer, SC (US)

(73) Assignee: Nfuzion Inc., Fayetteville, GA (US)

(21) Appl. No.: 13/735,699

(22) Filed: Jan. 7, 2013

Related U.S. Application Data
(60) Provisional application No. 61/584,022, filed on Jan. 6, 2012.

(51) Int. Cl. G06F 3/01

(52) U.S. Cl. CPC G06F 3/01
USPC 345/156

(57) ABSTRACT

Described herein are integration systems and methods for providing a cohesive user experience within an environment of a plurality of products. An exemplary integration system may comprise a gateway for bidirectional communication with the products. The integration system may also comprise a central or remote database defining the user interface design for a plurality of products, and a database that provides new features for a plurality of extensible products. An input to an interaction point on a first of the products may be transmitted to the gateway, which may interpret the input and transmit output instructions to the first product or to another product in the environment. Audio, visual, and tactile inputs and outputs may be provided through the gateway. In some embodiments, the database may provide a user interface skin or theme to the products, so that a standard look and feel is provided across the plurality of products.

### CROSS-REFERENCE TO RELATED APPLICATIONS

This application claims a benefit, under 35 U.S.C. §119(e), of U.S. Provisional Application Ser. No. 61/584,022, filed 6 Jan. 2012, the entire contents and substance of which are hereby incorporated by reference.

### TECHNICAL FIELD

Various embodiments of the invention relate to integration systems for a plurality of distinct products and, more particularly, to systems and methods for enhancing an environment by integrating a plurality of products into a cohesive user experience. The invention may apply to vehicle interiors or other environments.

### BACKGROUND

As vehicles are increasing in complexity, more distinct products are being included in a vehicle. These products may include GPS navigation systems, AM/FM radios, iPod integration devices, SiriusXM™ radio, sports score providers, stock tickers, traffic notifiers, CD players, media players, multi-zone HVAC systems, heated seats, rear seat entertainment products, power windows, power locks, power seats, and more. Further, users are bringing products into the environment, such as cell phones, laptops, and tablet computers. Many of these products include manufacturer-provided user interfaces that are difficult or costly to change, and thus these interfaces generally differ between the products in the environment.

Each product has different interface points and a different look and feel than the other products in the vehicle's environment. This creates a problem for the vehicle manufacturer as the user experience reflects on how the user feels about the vehicle's brand.

Another problem with the array of products in the vehicle is that there is unnecessary duplication of similar interface points. A navigation system may have its own voice recognition system separate from the voice recognition on a user's mobile phone. As a result, asking the products to call home has a very different user experience than asking the products to navigate home. This duplication of interaction points is both costly and inefficient.

### BRIEF DESCRIPTION OF THE FIGURES

FIG. 1 is a diagram of an integration system, according to an exemplary embodiment of the invention.

FIG. 2 is a diagram of an architecture of a computing device embodying part of the integration system, according to an exemplary embodiment of the invention.

### DETAILED DESCRIPTION

To facilitate an understanding of the principles and features of invention, illustrative embodiments are explained below. Various embodiments of the invention are integration systems and methods for integrating products for use within a single environment, where those products have more than a single manufacturer. In particular, embodiments of the integration system are described in the context of being used within a vehicular environment. The invention, however, is not limited to this context. Rather, embodiments may integrate devices in various other embodiments, such as within a home or facility.

The components described hereinafter as making up various elements of the invention are intended to be illustrative and not restrictive. Many suitable components that would perform the same or similar functions as components described herein are intended to be embraced within the scope of the integration systems and methods. Such other components not described herein may include, but are not limited to, for example, components developed after development of the invention.

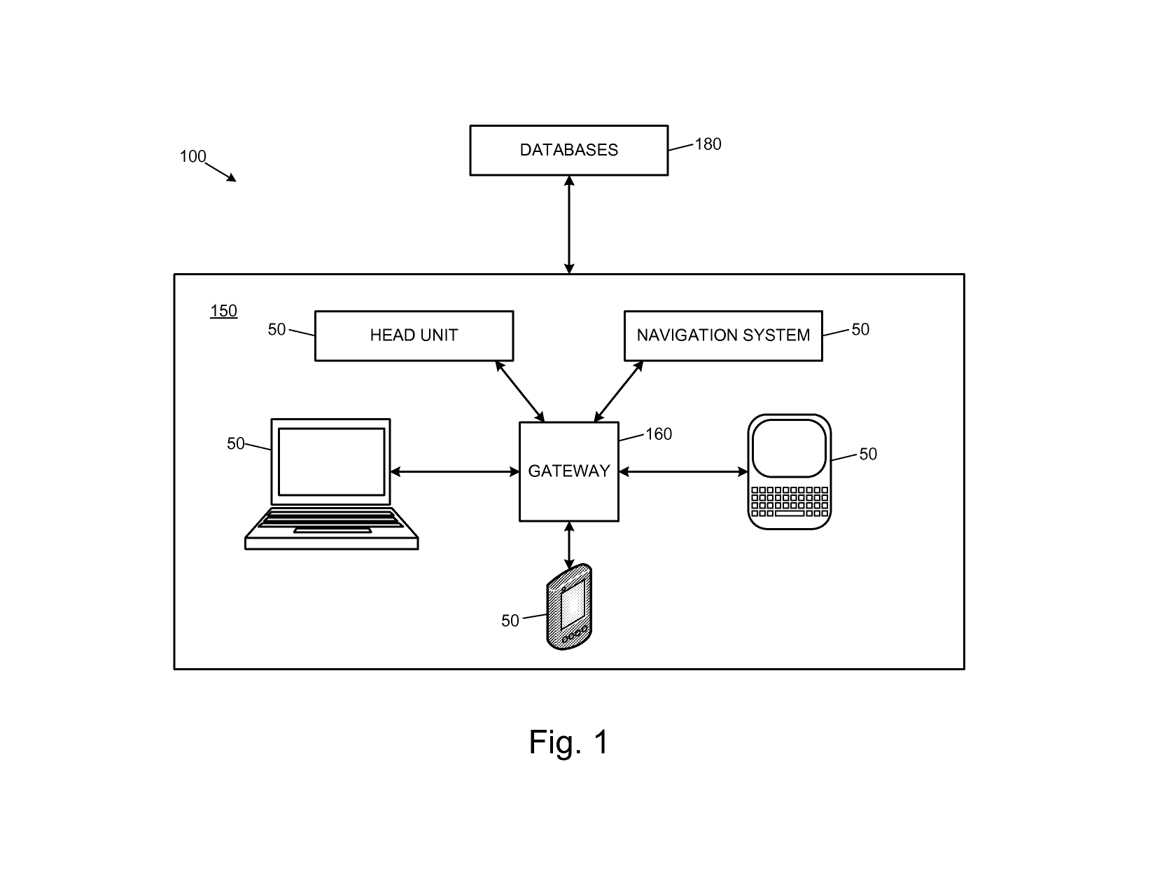

FIG. 1 is a diagram of an integration system 100, according to an exemplary embodiment of the invention. An exemplary embodiment of the integration system 100 may integrate products 50 from more than a single manufacturer. These products 50 may include various types of computing devices, including mobile devices or those integrated into the vehicle. For example, and not limitation, the devices may include smartphones, tablets, notebook computers, navigations systems, head units, instrument clusters, rear seat entertainment systems and center stack interfaces (e.g., knobs, touch interfaces, buttons and switches), and others. Integration may include one or more of the following: skinning and applying new themes to the user interfaces of the products, providing remote updates to the products, and tying the products to an interaction gateway and/or a central database to provide a cohesive experience.

In some embodiments, the integration system 100 may identify its environment 150. For example, if the environment 150 is a vehicle, the integration system 100 may detect the brand and/or model and/or trim of the vehicle from the vehicle's onboard computer. The integration system 100 may communicate with a local or remote database 180 to receive instructions related to how the environment should look and feel. In some embodiments, the database 180 may be at a remote server or provided in a computing cloud. It will be understood that a database useable with the integration system 100 need not be a relational database, so long as it incorporates a mechanism for maintaining data in an organized manner. If the environment 150 is identifiable, the look and feel may be customized to a brand associated with the environment.

For example, and not limitation, various software interfaces of various products 50 in the environment may be configured with a similar color scheme and layout. The database 180 may provide fonts, colors, graphical assets, pictures, layout information, color depth, auditory information, tactile information, or other data related to customization. For each product 50, an abstraction layer may separate the skin and theme from the hardware and low-level software. By defining and maintaining this abstraction layer, the integration system 100 may create system flexibility and gain complete management of the user experience. The integration system 100 may use the data received from the database 180 to configure various products in the environment.

The integration system 100 may provide extensibility of the various products 50 within the environment 150. To this end, the integration system 100 may query the remote database 180 for updates regarding various software products in the environment 150. Received updates may interact with the integration system 100 through a predefined application programming interface (API). By defining the extensible nature of a product, as well as defining and maintaining the APIs, the integration system 100 may create and add new features in the environment 150. When updates are received, the integration system 100 may apply them to the software in the environment.

Each product 50 may have its own user interface, which may include one or more interaction points at which a user may interact with the product 50. The user may create inputs to the product 50 at the interaction points. Such inputs may be audible commands, touch commands, visual commands, or a combination. In response to user commands or other instructions, e.g., predetermined instructions, a product 50 may return one or more outputs. An output may be audible, tactile, visual, or a combination thereof.

### A. An Exemplary Use of Some Embodiments

For example, the integration system 100 may be associated, and in communication with, a navigation product in a car or other vehicle. A user may speak a command to the navigation product. For this example, suppose the user says, “Find a gas station.” The navigation product may receive the audible command and respond with an audible reply, such as “Searching for a gas station.” It may then display a list of gas stations in the geographical area on the screen, thus providing a visual response.

The integration system 100 may comprise a gateway 160 through which user input and product output is transmitted and translated. In other words, the integration system 100 may be operationally between the user and the various products 50 of the environment. Thus, the user's command to search for gas stations may be received by one or more microphones in the environment 150, which may be a microphone of the navigation product or may be some other audio input device among the products in the environment 150 that is set to receive signals. When the user input is received, the receiving product 50 may transmit the input to the gateway 160, which may, if necessary, translate or otherwise modify the input before transmitting it to the navigation product or other destination product 50.

The integration system 100 may be in communication with a product 50 that acts as a gesture-receiving device, such as a camera or motion sensor, configured to receive physical gestures in the environment. In that case, returning to the navigation example above, the user may initiate scrolling through the search results with a gesture. For example, the user may wave a hand, and such gesture may be received by the gesture-receiving device. The gesture may be transmitted to the gateway 160, which may interpret the gesture and transmit an instruction to the navigation product. In response to the instruction, the navigation product may provide scrolling through the search results.

In some embodiments, the integration system 100 may provide tactile feedback, such as haptic feedback. For example, the user may select a desired location on a touchscreen among the products 50 in the environment 150, such as a touchscreen of the navigation product or some other touchscreen tied into the integration system 100. The touch may be transmitted to the gateway 160, which may determine that haptic feedback should be provided. Responsively, the gateway 160 may return an instruction to the touchscreen to provide haptic feedback. In turn, the touchscreen may fire a haptic response that “bumps” the user's finger to indicate that a location has been selected.

This example demonstrates the three different senses and their ingoing and outgoing interfaces. The integration system 100 heard the user, saw the user, and felt the user. The user heard a product 50, saw the results on a product 50, and felt a product 50 confirm his selection.

### B. Design Considerations for Some Embodiments

Below are some considerations that may be made while developing an embodiment of the integration system 100. It will be understood that not all considerations may apply to every embodiment of the invention, and considerations not provided below may also be applicable.

One or more of the product interfaces, particularly those integrated into the environment 150, may need to be tuned to achieve the designer's desired result. The voice recognition may need to be developed to understand the user. The microphone may need to be properly pointed at the user. The listening software may utilize an algorithm to reduce road and wind noise, as well as to filter out other people in the environment 150. Audio analysis software may need to be tuned to analyze various enunciations. The designer may specify which speakers provide voice prompts, and the volume of audio output may need to be defined. For example, the accent, the dialect, male or female voice, the pronunciation, or other aspects of audio input or output may need to be defined.

Similar considerations may apply to visual inputs and outputs. A designer may need to consider and define proximity sensor sensitivity, algorithms to interpret motion, and a working range and position of various sensors. A display configured to provide visual output may need to be designed and tuned for color depth, brightness, contrast, or viewing angle.

The touchscreen may need to be designed or selected from those available on the market. Touchscreen considerations may include some combination of the following: whether the system is a capacitive touch or a resistive touch screen, the resolution of touch points, how many touch points may be accepted at one time, support for swipes and gestures, and separation time between detectable touches. If a haptic feedback system is provided in association with the touchscreen, that system may have its own set of considerations, including, for example: speed of a bump, attack angle, vibration, and when to provide such feedback. Various haptic implementations may need to be considered, such as rotating motors, linear actuators, or piezo motors.

Presumably, the various manufacturers of the products 50 each use their own designs, and all the products in the environment are not directly compatible to a desired degree. Nonetheless, the integration system 100 may combine these distinct products into a cohesive user experience.

### C. Benefits of Some Embodiments

An exemplary embodiment of the present invention addresses some challenges presented by the existence of many products 50 within a single environment 150, by allowing the vehicle manufacturer to own the user experience and by reducing the costs of redundancy.

An exemplary integration system 100 of the present invention provides for all incoming and outgoing interfaces between the products 50 and the end user, as well as a methodology for the products 50 to communicate through the gateway 160. The gateway may take inventory of all or some of the possible inputs and output options. The vehicle manufacturer may then tune all of the interfaces at the gateway 160. Thus, the products in the vehicle environment 150 may perform some or all communications through the gateway 160.

For example, when scrolling through a list of options on a product tied to the integration system 100, audible clicks (as the list moves past predetermined trigger points) may be the same for the navigation product, the channel list from SiriusXM™, and the video selection list for the rear seat entertainment product. The same is true for haptic feedback and visual inputs and outputs. If audio, visual, or tactile feedback from one product 50 or application is different from another product 50 or application within the environment 150, the user experience can become disjointed and confusing. Thus, the gateway 160 may standardize the feedback provided within the environment 150. The gateway 160 may also allow interaction points from multiple locations to be routed to the one product 50. The gateway 160 may further allow one product 50 to communicate to multiple interaction points.

If mobile products 50 are brought into the vehicle environment 150, they too may reference the gateway 160 to understand what the human interface options are and to use the gateway 160 for user interactions.

Vehicle manufacturers are looking into ways be flexible with the visual representation of a product 50 as well as the how, what, where, and when the content, both provided and received via the user is represented by the system. When they make a change to the user interface design, they would like that design to be propagated across the plurality of the products 50 within the environment. The would also like to use the same hardware across different vehicle lines, where the identification of the vehicle by a centralized server or database 180 can define which user interface design to present to the products within the environment. Various embodiments of the invention may achieve these goals and more.

The above example is for a vehicle, but a gateway 160 and methodology may similarly be used in another environment 150 where multiple products 50 are used. For example, a home is another place where one might want a cohesive experience between, for example, the thermostat, the security system, information screens in the house, audio system, and various other human interfacing products.

### D. Computing Device Architecture

Various implementations of the integration systems 100 and methods may be embodied in non-transitory computer readable media for execution by a computer processor. For example, the gateway 160 or a server, comprising the databases 180 in communication with the integration system 100, may include one or more computing devices carrying such media, or various aspects of the integration system 100 within the vehicle environment may be or utilize computing devices.

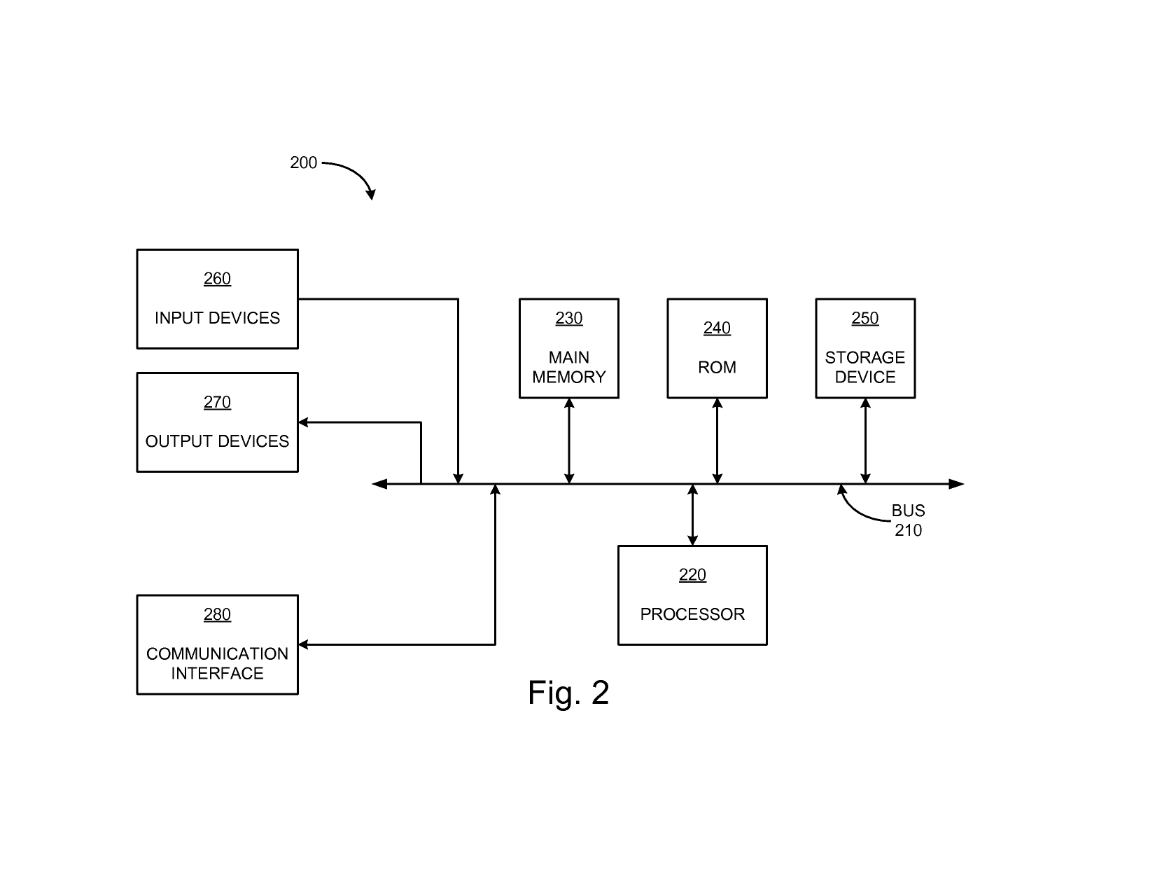

FIG. 2 is a diagram of an example architecture of a computing device 200 useable in some example embodiments. As shown, the computing device 200 may include a bus 210, a processor 220, a main memory 230, a read only memory (ROM) 240, a storage device 250, one or more input devices 260, one or more output devices 270, and a communication interface 280. The bus 210 may include one or more conductors that permit communication among the components of the computing device 200.

The processor 220 may be one or more conventional processors or microprocessors that interpret and execute instructions, such as instructions for providing aspects of the disclosed technology. The main memory 230 may include a random access memory (RAM) or another dynamic storage device that stores information and instructions for execution by the processor 220. The ROM 240 may include a conventional ROM device or another type of static storage device that stores static information or instructions for use by the processor 220. The storage device 250 may include a magnetic or optical recording medium and its corresponding drive.

The input devices 260 may include one or more mechanisms that permit an operator to input information to the computing device 200, such as a keyboard, a mouse, a pen, voice recognition, or biometric mechanisms. The output devices 270 may include one or more mechanisms that output information to an operator, including a display, a printer, or a speaker. The communication interface 280 may include any transceiver-like mechanism that enables the computing device 200 to communicate with remote devices or systems, such as a mobile device or other computing device 104 to which messages are delivered. For example, the communication interface 280 may include mechanisms for communicating over a network.

The computing device 200 may manage message delivery to the gateway 160 or other aspects of the integration system 100 as needed. The computing device 200 may perform tasks to that end in response to the processor 220 executing software instructions contained in a computer-readable medium, such as in memory 230. The software instructions may be read into memory 230 from another computer-readable medium, such as the data storage device 250, or from another device via the communication interface 280. Alternatively, or additionally, hardwired circuitry may be used in place of or in combination with software instructions to implement processes consistent with embodiments of the invention. Thus, the integration system 100 is not limited to any specific combination of hardware circuitry and software.

### E. Conclusion

While the integration system has been disclosed in exemplary forms, it will be apparent to those skilled in the art that many modifications, additions, and deletions may be made without departing from the spirit and scope of the system, method, and their equivalents, as set forth in the following claims.

What is claimed is:

1. An integration method comprising:
receiving a plurality of inputs from each of a plurality of computing products, including a first computing product and a distinct second computing product having distinct manufacturers, each computing product having an input device and an output device;
receiving, through a first communication channel with the first computing product, a first input provided at the first computing product through an input device of the first computing product;
translating the first input into data interpretable by the second computing product;
transmitting to the second computing product, through a second communication channel, the translated first input; and
instructing the second computing product to provide an output resulting from the first input at the first computing product.

2. The integration method of claim 1, further comprising instructing the second computing product to provide a specific output through an output device of the second computing product, based on the first input.

3. The integration method of claim 1, further comprising:
presenting a plurality of themes to a user;
receiving a selection of a selected theme from among the plurality of themes;
instructing each of the plurality of computing products to provide outputs in accordance with the selected theme.

4. The integration method of claim 3, the selected theme indicating a color and style of user interfaces for the plurality of computing products.

5. The integration method of claim 3, the selected theme indicating a set of audio outputs for the plurality of computing products.
